(19) United States
(12) Patent Application Publication
(10) Pub. No.: US 2017/0348868 A1
(43) Pub. Date: Dec. 7, 2017

(54) SPIRALIZING MANDOLIN

(71) Applicant: Progressive International Corporation, Kent, WA (US)

(72) Inventors: Justin Bagley, Seattle, WA (US); Sascha Kaposi, Tacoma, WA (US); Kyle Dean Aasness, Burien, WA (US)

(21) Appl. No.: 15/170,870

(22) Filed: Jun. 1, 2016

(51) Int. Cl. B26D 3/28; B26D 3/11

(52) U.S. Cl. CPC B26D 3/283; B26D 3/11; B26D 2210/02; B26D 2003/286

(57) ABSTRACT

A mandolin slicer includes a blade assembly suitable for making spiral cut slices, including a frame having a pair of opposing frame sidewalls and a downwardly extending lower support, a slicing ramp positioned at a first end of the mandolin slicer and between the pair of frame sidewalls, a runout plate positioned at a second end of the mandolin slicer and between the pair of frame sidewalls, and a blade assembly positioned between the pair of frame sidewalls.

### FIELD OF THE INVENTION

This invention generally relates to mandolin-type slicing devices.

### BACKGROUND OF THE INVENTION

Mandolin slicers are commonly used, and there are versions of mandolins for producing slices of food items of varying thicknesses. Mandolin slicers also sometimes include julienne blades extending vertically from the mandolin surface, for creating strips or cubes of a food item. To date, however, a mandolin has not been able to create a spiral cut food item. Instead, users must obtain and use a separate appliance for this purpose.

### SUMMARY OF THE INVENTION

The present invention relates to a mandolin slicer, particularly including a mandolin that can incorporate a blade assembly suitable for making spiral cut slices.

In one example of the invention, a mandolin slicer includes a frame having a pair of opposing frame sidewalls and a downwardly extending lower support, a slicing ramp positioned at a first end of the mandolin slicer and between the pair of frame sidewalls, a runout plate positioned at a second end of the mandolin slicer and between the pair of frame sidewalls, and a first blade assembly positioned between the slicing ramp and the runout plate, and further positioned between the pair of frame sidewalls.

The first blade assembly in one version includes a first spindle extending upwardly from the first blade assembly and located centrally between the pair of frame sidewalls, a first spiral slicing blade extending between the first spindle and one of the pair of frame sidewalls, and a first opening formed in the first blade assembly adjacent the first spiral slicing blade, the first opening along the length of the first spiral slicing blade.

The mandolin slicer may further include a hand guard removably attachable to the frame, the hand guard forming a central barrel and a peripheral flange.

In one version, the hand guard further comprises a guide and the pair of opposing frame members comprise a pair of rails, the guide engaging at least one of the pair of rails to retain the hand guard to the frame for sliding movement of the hand guard on the frame. In a further example, the guide may comprise a pair of guides joined to the pair of rails.

The mandolin in a preferred version includes a stop positioned on the slicer, the stop being configured to position the barrel of the hand guard about the spindle when the hand guard engages the stop.

The stop may be attached to a sidewall of the first blade assembly and extends laterally away from the first blade assembly, such that the guide engages the stop to position the barrel about the spindle.

In one example, when the guide engages the stop, the spindle is located at the center of the barrel.

A pusher cap is also provided in some versions, the pusher cap being configured to attach to the hand guard, the pusher cap further having a plunger plate supported by a piston and a grip attached to the piston, the piston extending through the pusher cap, whereby the grip, the piston, and the plunger plate are axially moveable within the barrel of the hand guard when the pusher cap is attached to the hand guard.

In one example, the plunger plate is attached for pivotal movement within the pusher cap.

The pusher cap may further have a lower body and a lid, the lid being attached to the lower body for rotational movement of the lid with respect to the lower body, and further wherein the piston extends through the lid and engaged with the lid for common rotational movement of the lid together with the piston.

The mandolin slicer preferably also includes a lock carried on the pusher cap, the lock being configurable between a locked position in which the lid is restricted from rotational movement with respect to the lower body, and an unlocked position in which the lid is rotationally moveable with respect to the lower body.

In a preferred example, one or more spikes are mounted to the lid and extending downward into the pusher cap, the plunger plate further having one or more holes, wherein the one or more spikes extends through the one or more holes.

In a version of the invention, the first blade assembly is removably mounted to the frame.

A preferred version with a removable blade assembly may also include a second blade assembly, the second blade assembly that includes a ridged or scalloped cutting blade.

In one version, at least a third standard slicing blade assembly may be provided.

### BRIEF DESCRIPTION OF THE DRAWINGS

Preferred and alternative examples of the present invention are described in detail below with reference to the following drawings:

FIG. 1 is a top front perspective view of a mandolin, shown with a pusher and hand guard in place over a slicing runout plate, and with a spiral slicing blade.

FIG. 2 is a top front perspective partial exploded view of a mandolin, shown with three interchangeable slicing blades.

FIG. 3 is a top front perspective view of a mandolin, shown with a standard slicing blade.

FIG. 4 is a top view of the mandolin of FIG. 1.

FIG. 5 is a bottom view of the mandolin of FIG. 1.

FIG. 6 is a top view of a preferred slicing blade.

FIG. 7 is a top view of a preferred scalloped spiral cut blade.

FIG. 8 is a top view of a preferred standard spiral cut blade.

FIG. 9 is a top perspective view of a preferred slicing blade.

FIG. 10 is a top perspective view of a preferred scalloped spiral cut blade.

FIG. 11 is a top perspective view of a preferred standard spiral cut blade.

FIG. 12 is a bottom perspective view of a preferred slicing blade.

FIG. 13 is a bottom perspective view of a preferred scalloped spiral cut blade.

FIG. 14 is a bottom perspective view of a preferred standard spiral cut blade.

FIG. 15A is a top rear perspective view of a mandolin, shown with a slicing ramp and other components removed.

FIG. 15B is a right side view of a mandolin, shown with a slicing ramp and other components removed.

FIG. 16 is a top view of a mandolin, shown with a standard spiral cut blade inserted, and with a hand guard positioned over the blade.

FIG. 17 is a bottom perspective view of the mandolin of FIG. 16.

FIG. 18 is a top front perspective view of the mandolin of FIG. 16, shown with the pusher positioned within the hand guard in a locked position.

FIG. 19 is a top front perspective view of the mandolin of FIG. 16, shown with the pusher positioned within the hand guard in an unlocked position.

FIG. 20 is a front view of a pusher and hand guard.

FIG. 21 is a sectional view of a pusher and hand guard, taken along line A-A in FIG. 20.

FIG. 22 is a bottom perspective view of the pusher and hand guard of FIG. 20.

FIG. 23 is a bottom exploded view of the pusher and hand guard of FIG. 20.

FIG. 24 is an exploded view of a preferred mandolin.

FIG. 25 is a side elevational view of a preferred slicing ramp and ramp support.

FIG. 26 is a side elevational view of a preferred julienne blade frame.

FIG. 27 is a side elevational exploded view of a preferred pusher cap.

FIG. 28 is an exploded perspective view of a preferred pusher cap, shown without a lock button.

FIG. 29 is a perspective view of a preferred pusher cap, shown without a lock button.

FIG. 30 is a top perspective view of a preferred lock button.

FIG. 31 is a side perspective view of a preferred lock button.

FIG. 32 is a bottom view of a preferred lock button.

### DETAILED DESCRIPTION OF THE PREFERRED EMBODIMENT

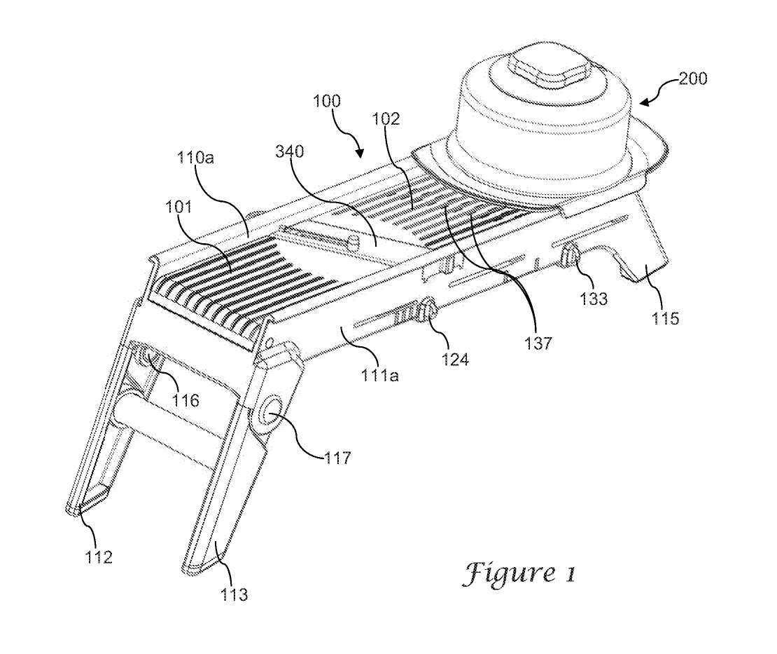

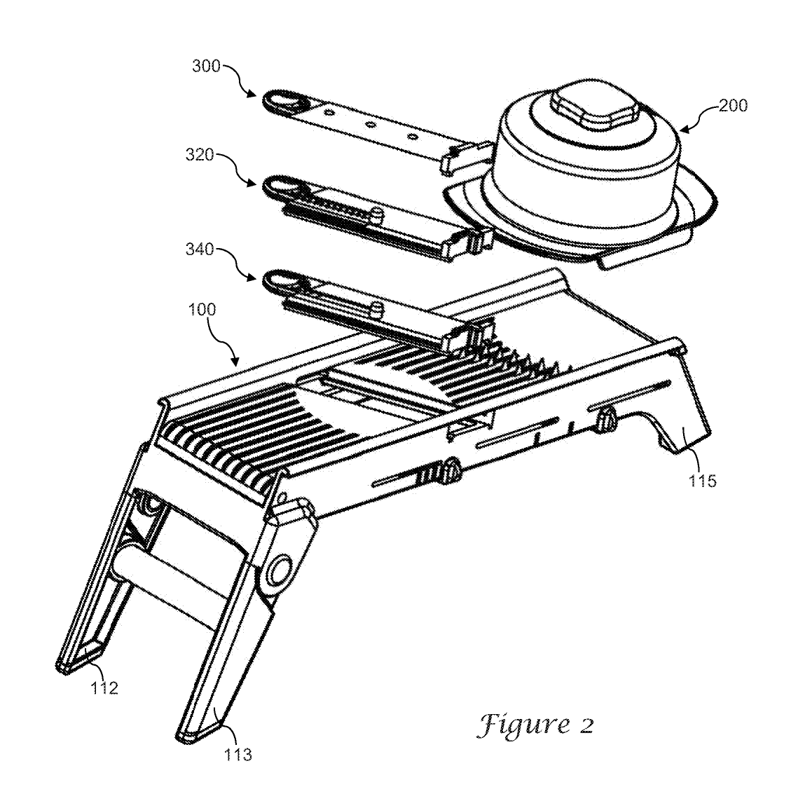

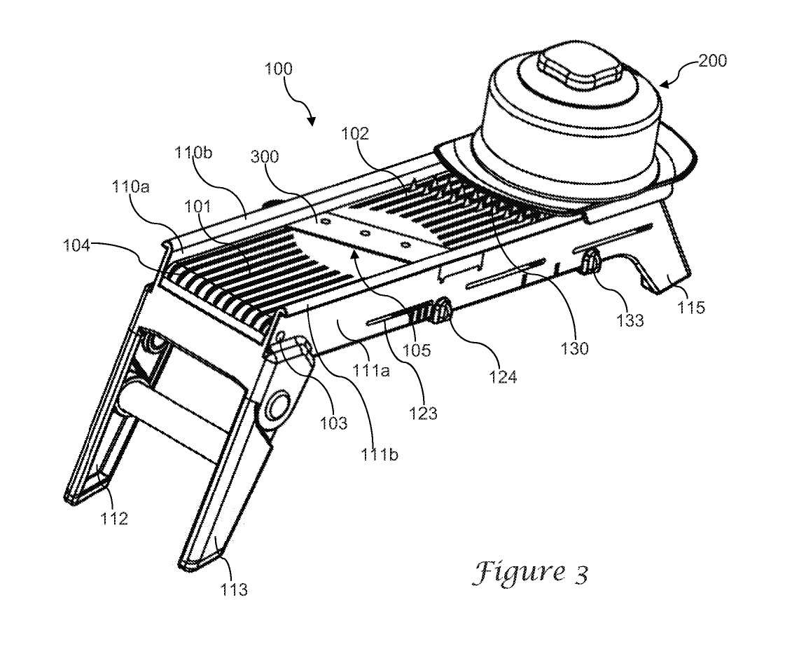

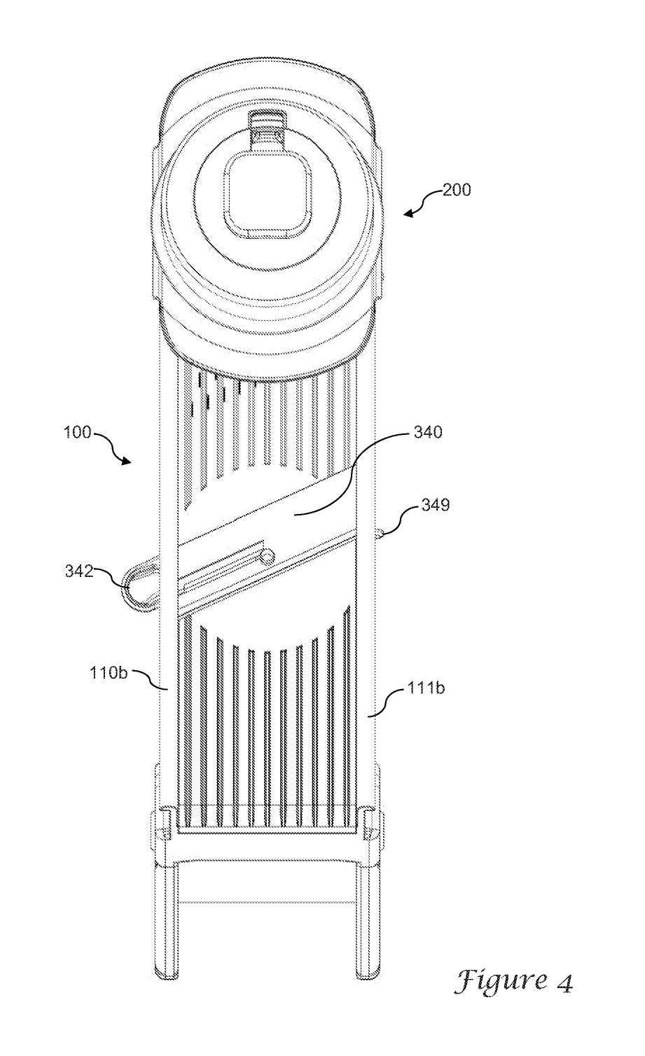

With reference to FIG. 1, a preferred version of a mandolin slicer 100 includes a central blade assembly (e.g., 300) and a combined hand guard and pusher 200. As shown in FIG. 1, the blade assembly is configured for processing a food item in a spiral cut fashion and therefore comprises a standard spiral cut blade assembly 340, as explained further below. In a preferred implementation, the blade assembly is interchangeable such as indicated by the exploded view of FIG. 2, in which the mandolin may be configured with a standard slicing blade assembly 300, a standard spiral cut blade assembly 340, or a scalloped spiral cut blade assembly 320. Yet other blade assemblies may also be provided. FIG. 3 illustrates the same preferred mandolin, but with a standard slicing blade assembly 300 installed instead of the standard spiral cut blade assembly 310.

In the configuration of FIG. 3, the mandolin includes a slicing ramp 101 and a runout plate 102, the slicing ramp and runout plate being separated by the slicing blade 300. The slicing blade includes a sharpened edge facing toward the slicing ramp 101 so that a food item moving in a direction from the slicing ramp toward the slicing blade will encounter the slicing blade and be sliced accordingly.

A frame is provided on either side of the mandolin, including a first frame member 110a formed as a first vertical sidewall and having a first upper side rail 110b extending above the slicing ramp, with a second frame member 111b with a second sidewall on the opposite side of the slicing ramp, the second frame member having a second side rail 111b extending above the slicing ramp. As shown, the slicing ramp and runout plate are positioned between and supported by the two frame members. Preferably, the slicing ramp 101 is pivotally attached to the mandolin between the first and second frame members at a pivot location 103. A gap 105 is provided between the slicing ramp 101 and the sharpened edge of the slicing blade 300 such that the slicing ramp may be raised or lowered as desired to increase or decrease the size of the gap, thereby adjusting the size of the slice for the food item. As illustrated, the slicing ramp and runout plate are planar and lie in a common plane when the slicing ramp is raised to its highest position.

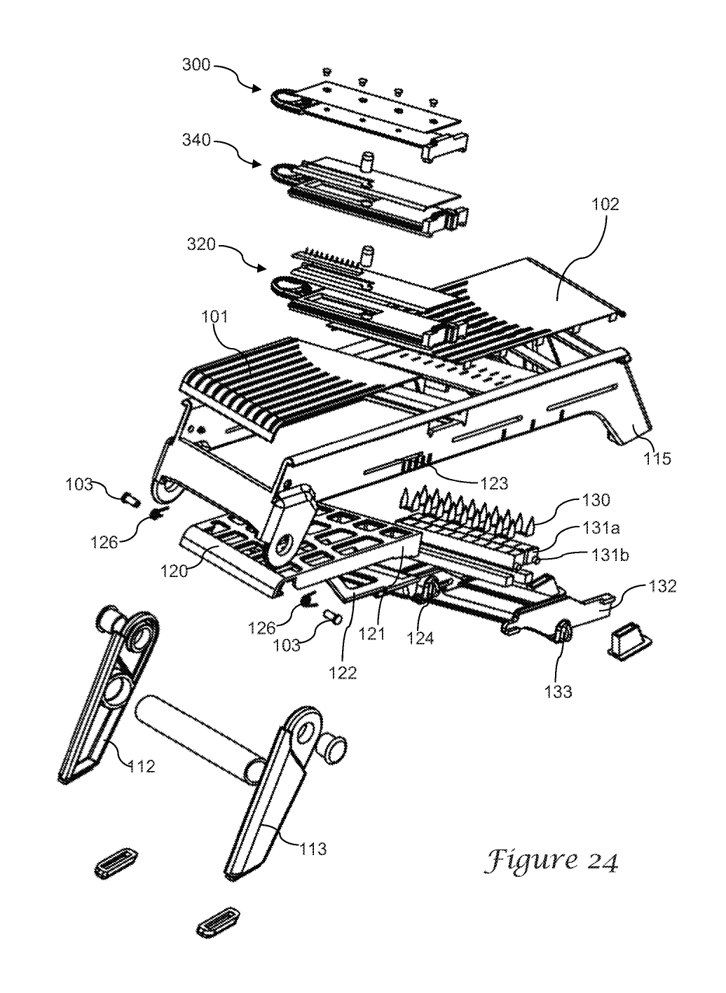

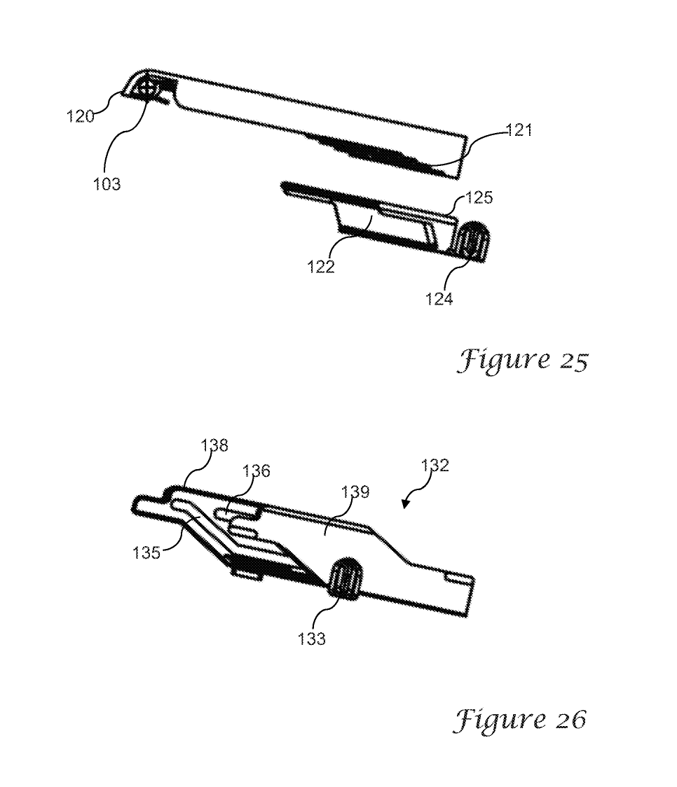

The slicing ramp may be raised and lowered in any fashion to adjust the slicing thickness, and in one version the slicing ramp 101 is supported by a ramp support 120 having an inclined or stepped lower surface 121, such as best seen in the exploded view of FIG. 24, and isolated in the elevational view in FIG. 25. The lower surface of the ramp support encounters a horizontally moveable selector plate 122, which slides along a slot 123 formed in the second frame member 11a and a corresponding slot in the first frame member 110a. A selector knob 124 allows a user to move the selector plate horizontally (back and forth in a direction from the slicing ramp toward the runout plate, and back again). The horizontal movement causes an upper surface 125 of the selector plate 122 to encounter a different portion of the inclined or stepped lower surface 121 of the ramp support 120, thereby raising or lowering the distal end of the slicing ramp adjacent the slicing blade as it pivots about the pivot point 103. The pivot point 103 may be constructed as a single axle, a pair of posts, or other configurations to pivotably mount the ramp support to the frame. One or more springs 126 may be carried on the axle or posts to bias the ramp support downward against the selector plate. It should also be appreciated that the slicing ramp may be raised or lowered using different structures, including for example a ramp support that moves up and down vertically without pivoting about a pivot location.

The runout plate 102 optionally also includes one or more sets of vertically extending blades 130 for cutting food items into strips or cubes. The vertically extending blades 130 are preferably mounted to a pair of bars 131a (see FIG. 24) having stems 131b trained to slots 135, 136 formed in the sidewalls 138, 139 of a julienne blade mount 132. The slots are best seen in FIG. 26, and include a lower horizontal portion transitioning to an inclined portion and an upper horizontal portion. A pair of such slots are provided on the inner side of each sidewall of the julienne blade mount 132, and as indicated in FIG. 26 a first pair of slots 135, 136 are provided in a first sidewall 138. A symmetrical pair of slots (not visible in FIG. 26) is formed in the opposing second sidewall 139 of the blade mount 132.

The julienne blade mount includes a selector knob 133 extending outside the frame sidewall 111a when it is assembled, to allow a user to move the julienne blade mount horizontally to selectively extend or retract one or both of the sets of vertically extending blades by urging the blade bars 131a along the slots as described above, thereby causing the blades to extend through (or retract from) a corresponding number of slots 137 formed in the runout plate. In other versions of the invention, the vertical slicing blades may be supported or extended using a different support structure. Likewise, in other versions of the invention no vertically extending blades are incorporated into the mandolin, or they may be configured to extend through the slicing ramp rather than the runout plate.

The frame, including first and second side frame members 110a, 111a, are supported by one or more front legs 112, 113 and one or more rear legs 114, 115. The legs, or other support structure, provide support for the mandolin slicer when resting on a horizontal surface such as a countertop. The legs or support structure thereby extends downwardly while the frame sidewalls extend in an upward direction from the upper surface of the slicing ramp and runout plate. In the illustrated example, the front legs are longer than the rear legs such that the slicing ramp and runout plate form an incline, angled downward from the slicing ramp toward the runout plate when the legs are resting on a horizontal surface. In the illustrated version, the front legs 112, 113 are articulated at a pivot location 116, 117, allowing the front legs to fold inward toward the slicing ramp for more compact storage.

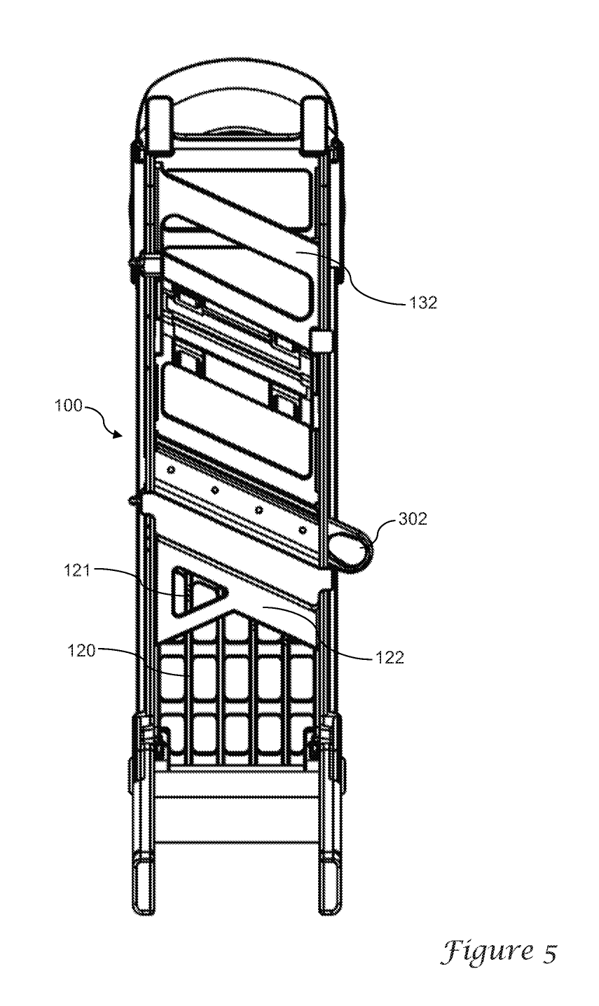

The legs 112-115 extend downwardly from the mandolin 100, generally from the frame members away from a lower surface of the slicing ramp 101 and runout plate 102. Accordingly the upper surface of the slicing ramp 101 and runout plate is visible in FIG. 1, while a lower surface of the slicing ramp and runout plate are partially shown in FIG. 5, obscured by additional support structures described below.

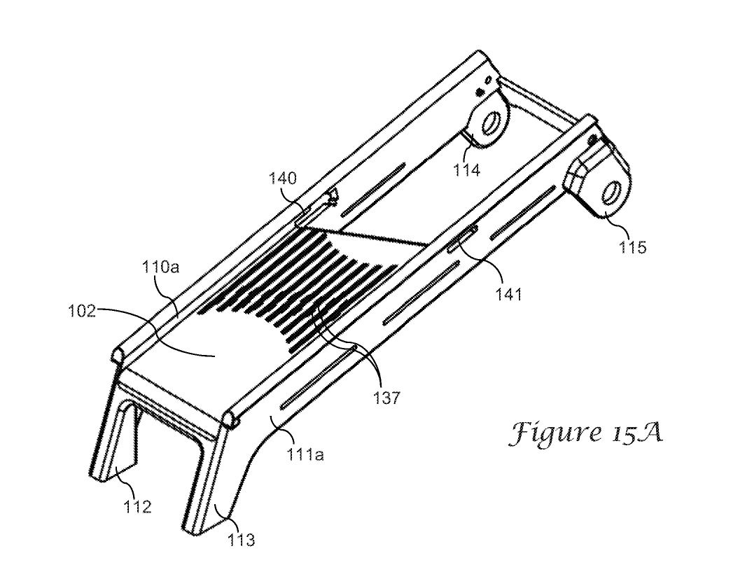

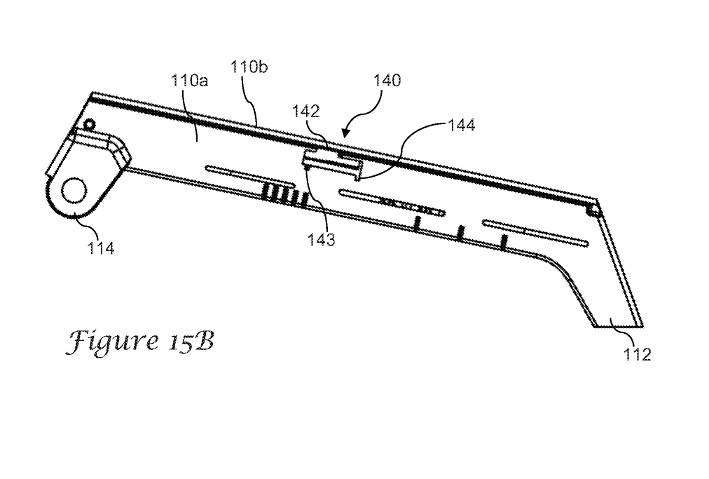

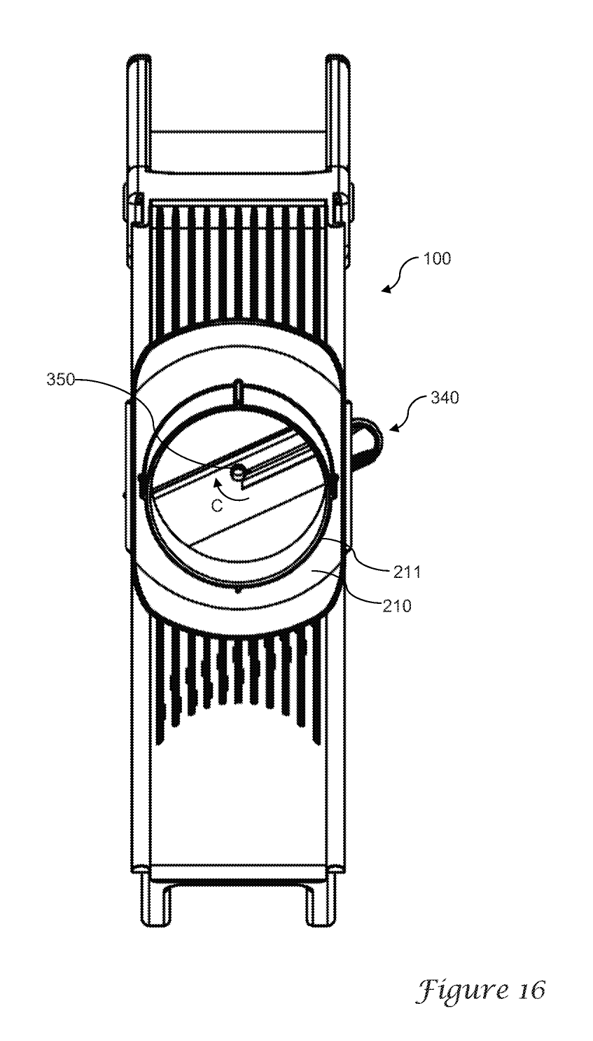

In the preferred version of the invention, the slicing blade assemblies 300, 320, 340 are removable and thereby interchangeable. In other versions a single slicing assembly may be provided. With reference to FIG. 15A (which is reversed in orientation with respect to FIG. 1) and FIG. 15B, in the preferred version the frame includes a pair of opposing slots 140, 141 formed in the first and second frame members 110a, 111a. The first slot 140 is configured with features allowing the insertion of the slicing assemblies, as discussed below, while the second slot 140 allows a locking tab to extend through the second slot to selectively lock the slicing assembly in position or enable it to be released.

The side view of FIG. 15B shows a preferred shape of the first slot in greater detail. In one version, an upper edge of the slot is formed with a raised cutout 142, configured to receive an upwardly extending spindle of a spiral slicing blade assembly as discussed below. The opposite lower edge of the slot 140 is preferably formed with a pair of vertical channels 143, 144, with one positioned at each of the forward and rearward ends of the slot 140. It should be appreciated that the slot 140 may be configured with a different shape that enables it to removably receive and retain a slicing assembly, in an embodiment in which the slicing assemblies are replaceable. The opposing second slot 141 is preferably formed with a substantially rectangular shape.

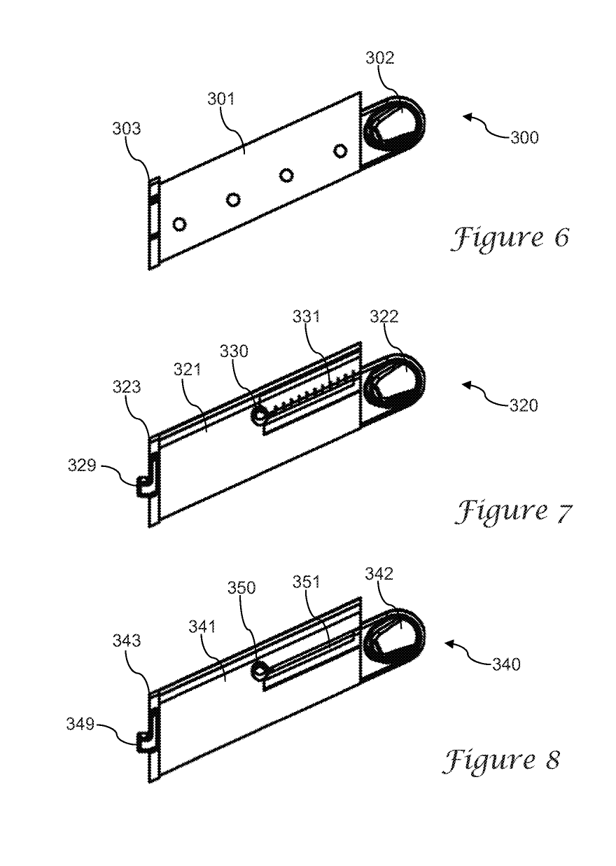

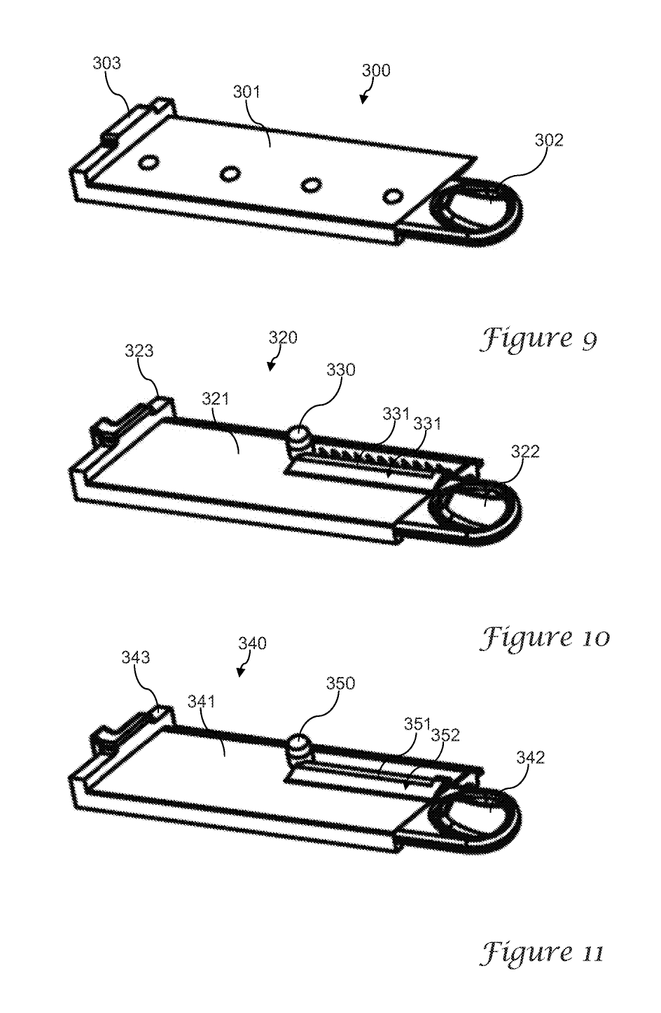

Preferred versions of slicing assemblies are illustrated in FIGS. 6-14, including a standard slicing blade 300 (FIGS. 6, 9, and 12), a scalloped spiral blade assembly 320 (FIGS. 7, 10, and 13) and a standard spiral blade assembly 340 (FIGS. 8, 11, and 14).

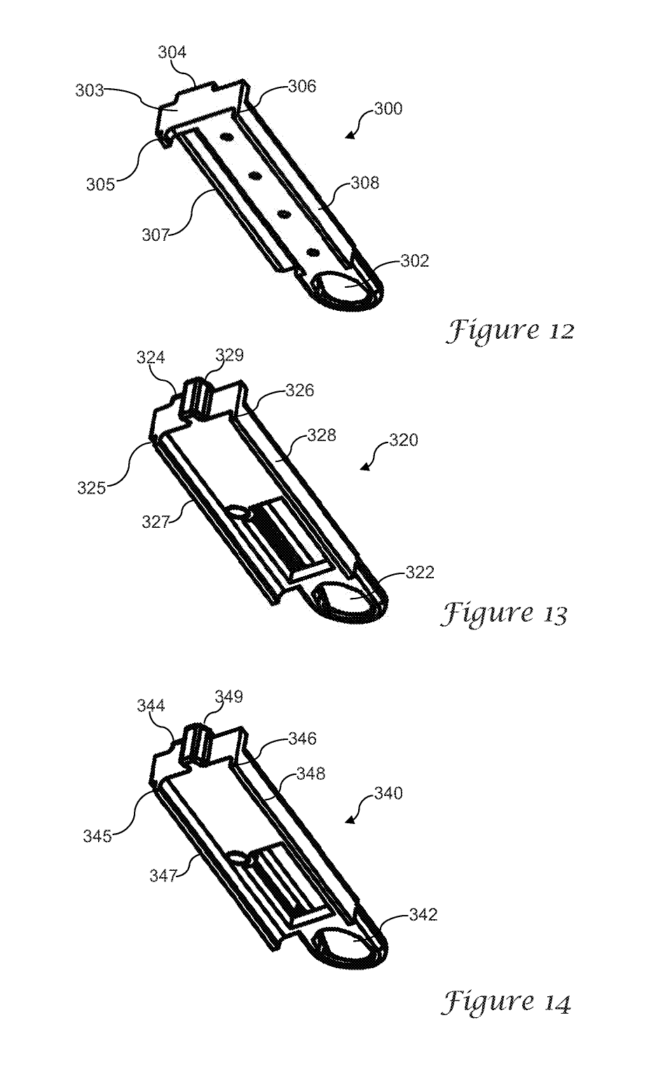

The standard slicing blade assembly 300 is formed with a main blade 301, preferably constructed from stainless steel. A first end is mounted to a locking tab 302 while the opposing second end is mounted to a keyed endcap 303. The keyed endcap is configured with a shape that is complementary to the shape of the first slot 140, such that the endcap snugly fills the first slot 140 when the blade assembly is fully inserted and in position for use. Thus, as best seen in FIG. 12, the endcap 303 preferably includes an upwardly-extending central tab 304, and a pair of downwardly extending tabs 305, 306, in an otherwise generally rectangular endcap. The leading, sharpened edge 307 of the blade 301 is oriented toward a first one of the downwardly extending tabs 305, and is preferably unsupported immediately below the sharpened edge. The rearward edge of the blade is supported by a rail 308 generally having a cross sectional shape that matches the second downward tab 306. The rail 308 provides some structural support, and further guides the assembly into the slot 140 during insertion and removal. The outer surface of the end cap 303 is configured to be substantially flush with the side wall 111a when the assembly is inserted, such that the hand guard can slide along the side rails without being impeded by the end cap. The locking tab 302 is formed with a button providing a vertical shoulder that engages the side wall 111a of the frame member when inserted, thereby impeding removal of the assembly 300. When a user applies a downward force on the locking tab it deflects downwardly so that it can be received through the second slot 141, allowing the assembly 300 to pass through both the first and second slots 140, 141.

The scalloped spiral blade assembly 320 is configured in a similar fashion as with the standard slicing blade, including a locking tab 322 and an end cap 323. The central portion 321 of the assembly, however, is not configured with a standard slicing blade. Instead, the assembly includes a spindle 330 and a ridged spiral slicing blade 331 positioned on one side of the spindle, preferably with no blade formed on the opposite side of the spindle. In the illustrated example, the spindle 330 is positioned mid-way between the locking tab 322 and the end cap 323, and slightly toward the leading edge 327 of the central portion of the assembly. Thus, in the illustrated version, the scalloped spiral slicing blade is positioned between the spindle and the locking tab but not between the spindle and the end cap. In other versions, the position of the blade may be reversed. An opening 332 is provided in the central blade assembly adjacent the blade 331, in which both the opening and the blade extend between the spindle 330 and one of the frame sidewalls.

The central portion 321 of the assembly 320 is preferably formed from stainless steel, with the spindle 330 being formed from stainless steel as a short hollow cylinder. As such, a food item mounted on the spindle will be supported by the spindle for rotation on the cylinder. A portion of the food item will be cut by the cylinder as it rotates, thereby creating a cylindrical section of a food item such as a potato. The cylindrical food item then passes through the hollow cylinder and can fall through to the open bottom of the mandolin. In other versions, the spindle may be formed as a solid spike, for example.

The end cap 323 of the scalloped spiral slicing assembly 320 is formed in a shape similar to the end cap of the standard slicing blade, and includes an upwardly-extending central tab 324, and a pair of downwardly extending tabs 325, 326. The forward edge 327 of the central portion of the assembly 321 is oriented toward a first one of the locking tabs 325, and is preferably supported by a first rail 327 extending immediately below the leading edge and having a cross sectional shape matching the first downward tab 325. The rearward edge of the assembly is supported by a second rail 328 generally having a cross sectional shape that matches the second downward tab 326. The rails 327, 328 provide some structural support, and further guide the assembly into the slot 140 during insertion and removal.

Unlike the standard blade, the outer surface of the end cap 323 is not configured to be substantially flush with the side rail, because in the preferred version it is desirable to provide a stop for the hand guard to help position it over the blade, as discussed further below. Accordingly, the end cap 324 is preferably formed with an outwardly-extending stop 329, which in the illustrated version extends laterally outward from the end cap.

The standard spiral blade assembly 340 is configured in substantially the same fashion as with the scalloped version, except that the blade is planar and does not have ridged or scalloped edges. Thus, it includes a locking tab 342 and an end cap 343 positioned on opposite sides of a central portion 341. The assembly includes a spindle 350 and a spiral slicing blade 351 positioned on one side of the spindle, preferably with no blade formed on the opposite side of the spindle. An elongated opening 352 is positioned beneath the 351 blade, running the length of the blade. Thus, in the illustrated version, the spiral slicing blade is positioned between the spindle and the locking tab but not between the spindle and the end cap. In other versions, the position of the blade may be reversed.

The central portion 341 of the assembly 340 is preferably formed from stainless steel, with the spindle 350 being formed from stainless steel as a short hollow cylinder. As noted above, the spindle may be configured as a spike or in other shapes. The end cap 343 of the spiral slicing assembly 340 is formed in a shape similar to that of the other described assemblies, and includes an upwardly-extending central tab 344, and a pair of downwardly extending tabs 345, 346. The forward edge 347 of the central portion of the assembly 341 is oriented toward a first one of the locking tabs 345, and is preferably supported by a first rail 347 extending immediately below the leading edge and having a cross sectional shape matching the first downward tab 345. The rearward edge of the assembly is supported by a second rail 348 generally having a cross sectional shape that matches the second downward tab 346. The rails 347, 348 provide some structural support, and further guide the assembly into the slot 140 during insertion and removal. The end cap 343 is preferably formed with an outwardly-extending stop 349, which in the illustrated version extends laterally outward from the end cap.

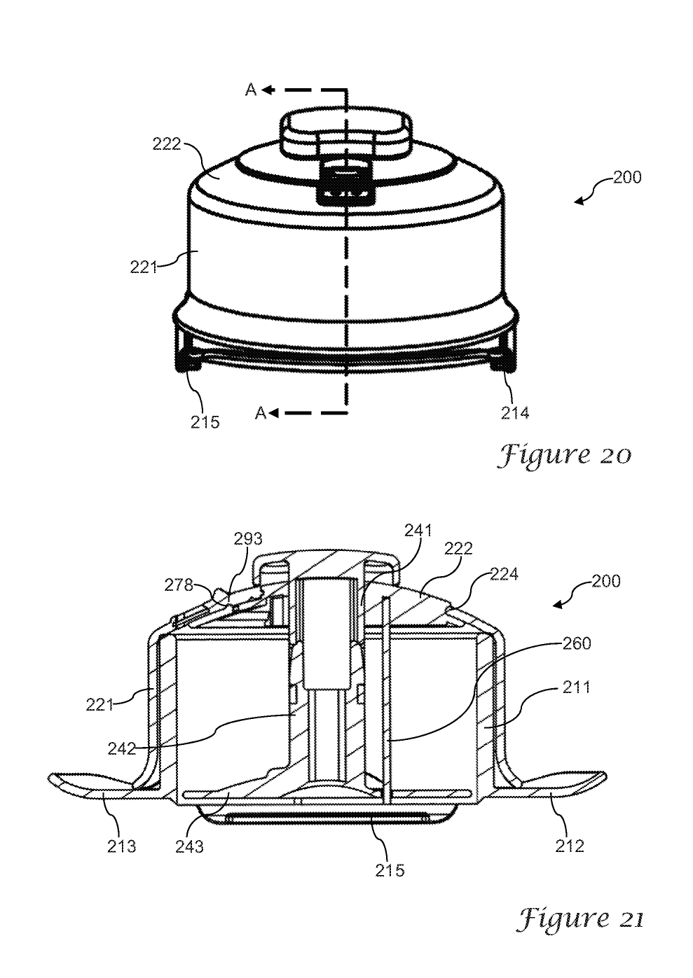

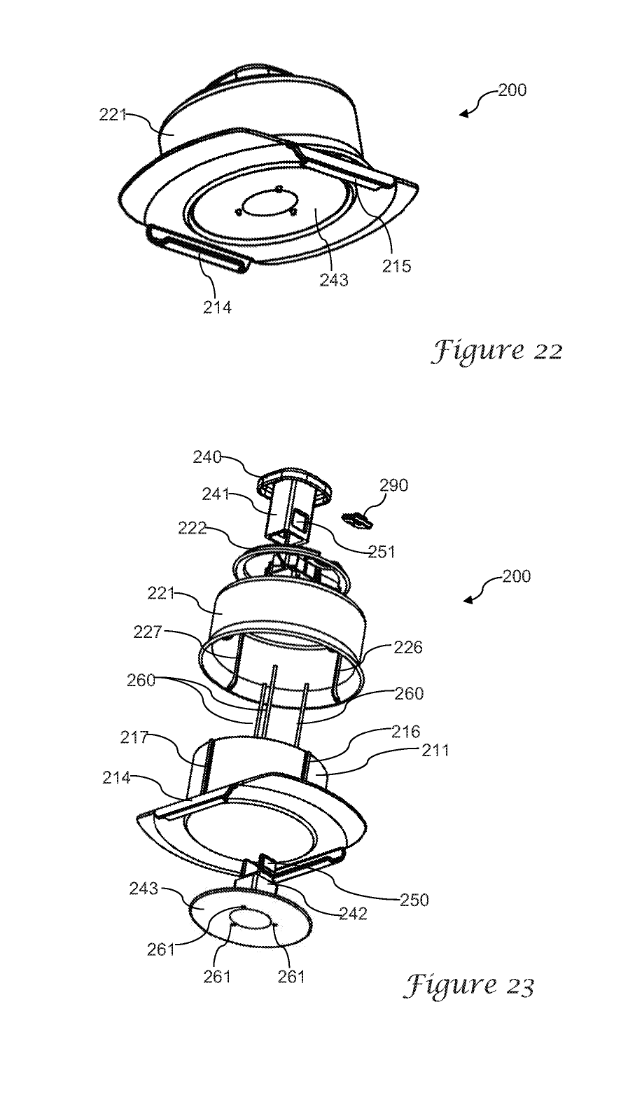

A preferred mandolin further includes a combined hand guard and pusher assembly 200, shown in position on the mandolin in several of the figures and best seen in isolation in FIGS. 20-23. The assembly includes a hand guard 210, formed with an upper cylindrical barrel 211 and a lower peripheral flange. Most preferably, the flange includes a forward portion 212 and a rearward portion 213. Between the forward and rearward portions, a lower section of the hand guard is configured with a pair of opposing guides 214, 215 which extend downward and inward from the barrel to engage the side rails 110b, 111b of the mandolin frame. The engagement of the guides with the side rails serves to hold the hand guard to the side rails and allow it to travel smoothly along the upper surface of the slicing ramp and runout plate. The barrel further includes a plurality of vertical ribs, e.g. 216, 217, preferably including four such ribs placed on the outer surface of the barrel and located at 90 degree intervals about the circumference of the barrel.

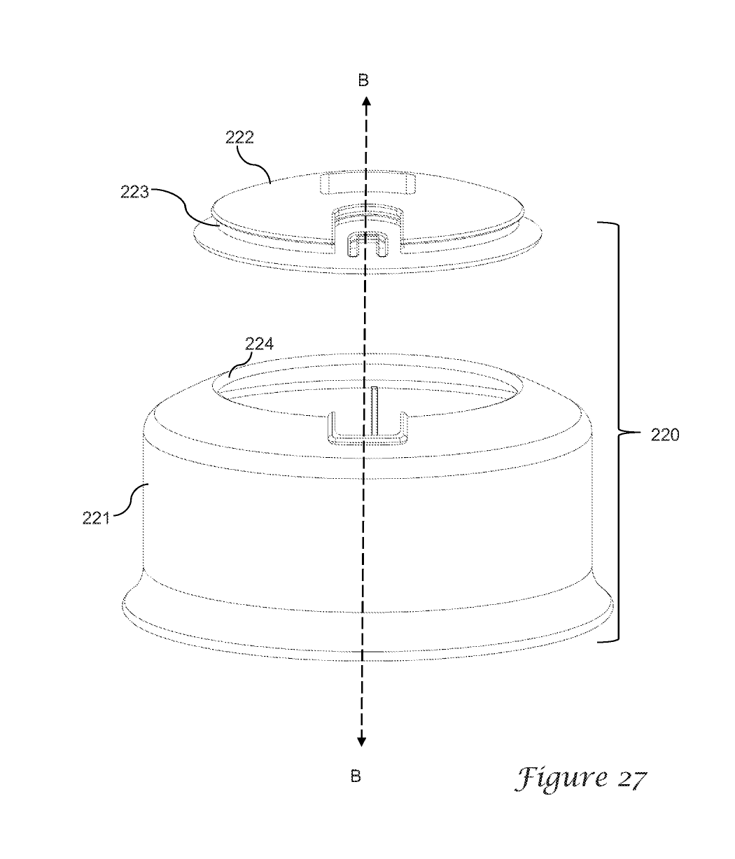

The barrel is surrounded by a pusher cap 220 (see FIG. 27) having a mating cylindrical shape to receive the barrel within the pusher cap. The pusher cap serves as an outer grip for the combined pusher and hand guard. In the preferred version, the pusher cap is formed in two pieces, including a lower body 221 and an upper lid 222, the upper lid being mounted to the lower body for rotation with respect to the lower body. The lower body preferably terminates in an open top having a circular rim 224. The lid is configured with a lower annular groove 223, such that the rim 224 and groove 223 are sized and configured to allow the rim to be received within the groove. In this manner, the lid is snap-fit to the lower body while allowing the lid to rotate within the open top of the lower body, about a central axis B as indicated in FIG. 27.

The interior sidewalls of the lower body of the pusher cap are preferably formed with a plurality of ribs (e.g., 226, 227), as best seen in FIG. 23. As with the barrel 211, the ribs are preferably located at 90 degree intervals about the circumference of the lower body. In a version in which four ribs are provided on each of the barrel and lower body, the barrel is able to rotate 90 degrees with respect to the lower body in either direction (about a central axis such as axis B in FIG. 27) before the ribs encounter one another and act as stops against further rotation. It should be appreciated that other engaging surfaces may be provided, in which the engagement surfaces interact with one another in the same fashion but without being shaped as ribs.

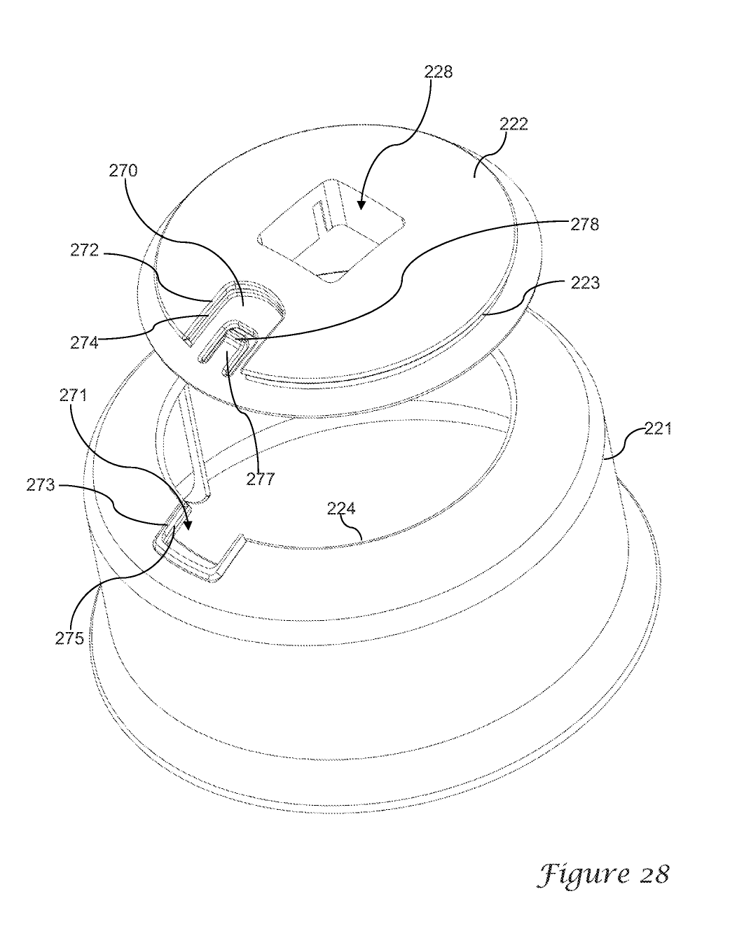

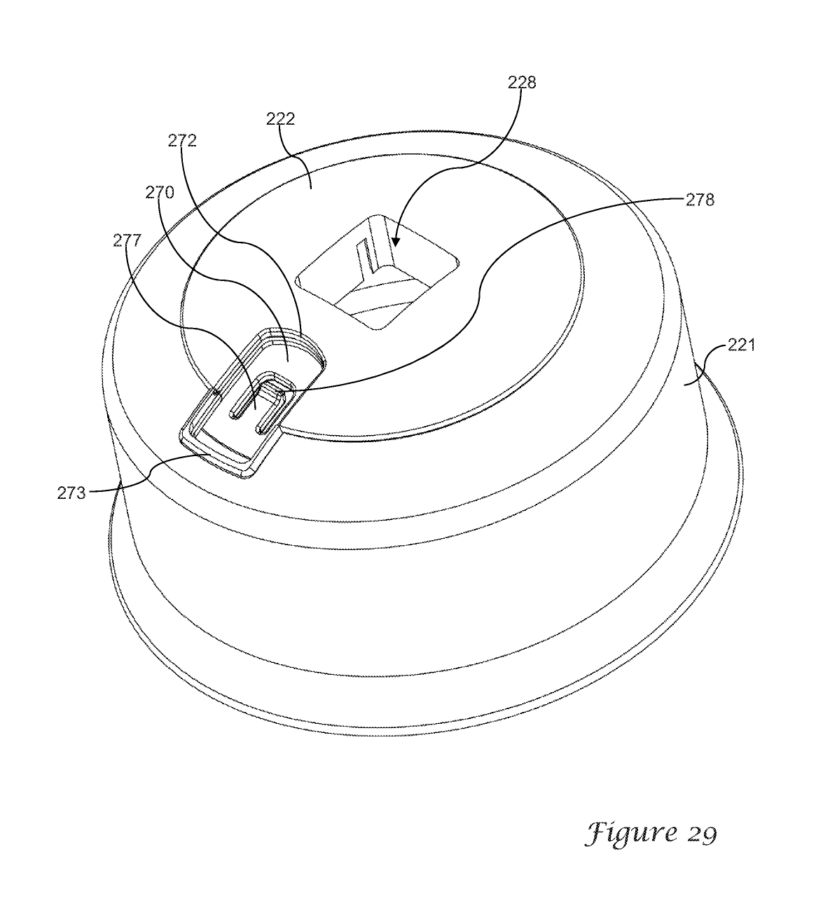

While the lid 222 is configured to rotate within the rim of the lower body 221, in a preferred version the lid (or the lower body) is configured with a lock to allow the user to selectively lock the lid against rotation or unlock the lid to allow rotation. In an illustrated version (see FIGS. 28-32), the lid 222 includes a seat 270 configured to receive a lock button 290. The seat is best seen in FIGS. 28 and 29, in which the lock button has been removed for clarity. The seat 270 is preferably formed as a recessed portion within the lid, and is also partially bounded by a cutout 271 formed on a portion of the inward rim 224 of the lower body 221. The seat is surrounded by a sidewall which is includes a first sidewall portion 272 formed in the lid and a second sidewall portion 273 formed along the cutout 271. In one version, the lock button is secured and slides within the seat in a tongue-and-groove fashion, and in the illustrated example the sidewall includes a groove that includes a first groove portion 274 and a second groove portion 275.

A locking retainer 277 shaped as a pawl with an upwardly extending tooth 278 is provided in the lid 222, surrounded on three sides by an opening through the lid so that the retainer may flex upward or downward. As described below, the retainer engages a lower surface of the locking tab to hold it in a desired locked or unlocked position.

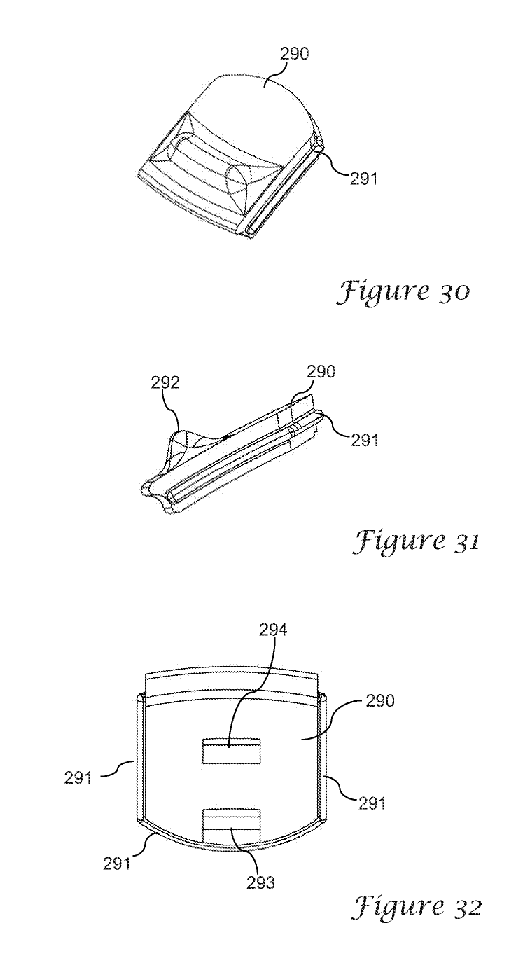

A preferred locking button 290 is shown in FIGS. 30-32. The illustrated version includes a peripheral tongue 291 extending from three of the four sidewalls of the button. The tongue is received within the groove 274, 275, described above. When positioned within the seat 270, the locking button 290 is able to slide radially inward and outward, with the tongue engaging the groove. A knob 292 is provided on an upper surface of the button, preferably shaped in a fashion that is engagable by a thumb of a user. A lower surface of the button 290 (best seen in FIG. 32) is formed with a pair of cavities, including a first cavity 293 and a second cavity 294. Each of the first and second cavities is configured to receive the tooth of the locking retainer 277 to bias the button in a desired position.

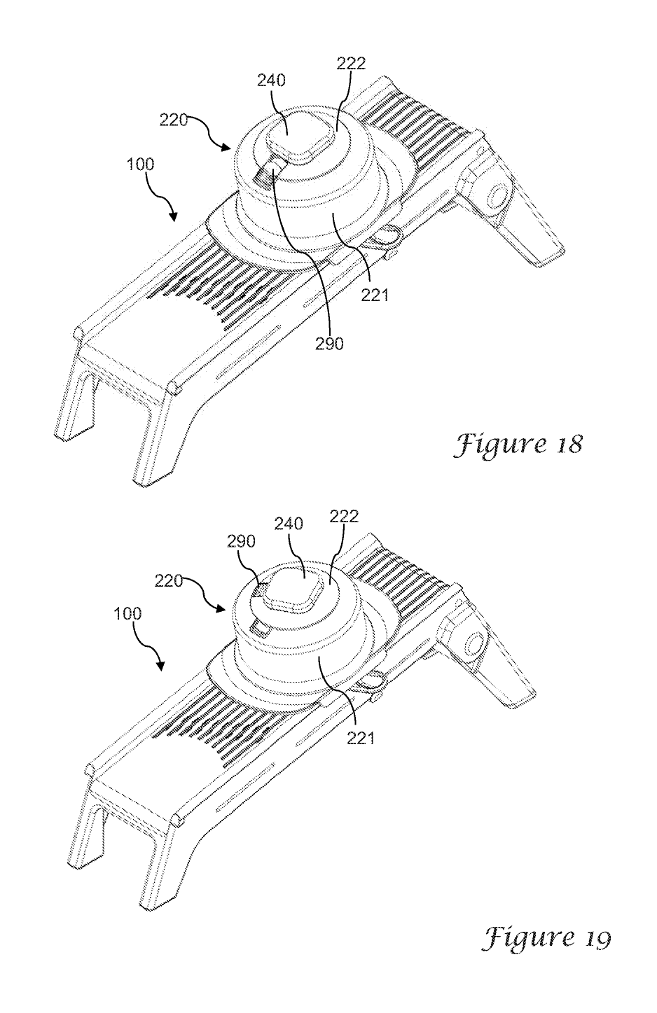

The lid and plunger are shown in a locked position in FIG. 18. In this position, the button 290 is moved radially outward within the seat, in a direction away from the grip 240. The tooth 278 on the locking retainer is in engagement with the second cavity 294, thereby holding the button in position. As seen in FIG. 18, the button straddles the rim 224 of the lower portion 221, thereby impeding rotational movement of the lid 222 with respect to the lower portion.

The lid and plunger are shown in an unlocked position in FIG. 19, and further in which the lid has been rotated a distance with respect to the orientation of FIG. 18. In this position, the locking button 290 has been moved radially inward toward the grip 240, thereby removing the impediment against rotational movement of the lid. The tooth 278 on the locking retainer is now in engagement with the first cavity 293, thereby holding the button in position. In order to move between the locked and unlocked positions, a force is applied radially (either inward or outward, as desired) to move the button. The urging force must be sufficient to deflect the tooth 278 in order to dislodge it from the applicable cavity so that the button can be moved to the other position, seating the tooth 278 in the other cavity 294.

A plunger extends through the lid 222, positioned for axial movement (along axis B) with respect to the lid and within the pusher cap. In one preferred version, the plunger includes a grip 240 attached to a piston. The piston may be formed in two sections, including an upper piston section 241 (which may be integrally formed with the grip), and a lower piston section 242 (which in the illustrated version is integrally formed with a plunger plate 243). In one example, the upper piston section 241 is formed with a rectangular cross section and is received within an opening 228 in the center of the lid 222 having a mating shape. The upper piston and the opening in the lid may have different shapes, but most preferably they are complementary and engage one another such that rotation of the grip and piston about the axis B will cause simultaneous rotation of the lid (which, as described above, is attached for rotation with respect to the lower body).

After the upper piston section is passed through the lid, it is joined to the lower piston section 242. In the illustrated version, the lower piston section includes a pair of legs formed with feet 250 configured to engage a pair of openings 251 formed in the upper piston section. The two piston sections thus may be snap-fit together, or may be glued, sonic-welded, or otherwise attached. Likewise, the piston may be formed as a single component rather than having upper and lower sections, with a plunger plate attached to the lower end of the piston. When assembled and in position, a user may grasp the grip to move the plunger (including the piston and plunger plate) upward or downward with respect to the hand guard. The user may also rotate the grip and thereby rotate the lid and plunger plate with respect to the hand guard, as long as the lid 222 is unlocked with respect to the lower body 221.

The lid may further include one or more spikes, such as stainless steel spikes 260. The spikes are preferably formed as relatively thin rods which are permanently secured to the lower surface of the lid 222, such as best seen in the sectional view of FIG. 21. The spikes extend through holes 261 formed in the plunger plate 243 (best seen in FIG. 23), so that the spikes rotate together with the plunger plate 243, grip 240, and lid 222. The holes 261 in the plunger plate allow the plunger plate to slide axially up and down the length of the spikes while the spikes remain in a fixed axial position. Accordingly, the spikes can pierce a food item positioned within the interior volume of the barrel and pusher cap, while the plunger plate is raised to accommodate the food item and can be pushed downward to urge the food item toward the blade assembly.

A preferred mandolin is shown in position for making spiral cuts in FIG. 16. When in use for making spiral cuts of a food item such as a carrot, zucchini, potato, or cucumber (for example), the barrel 211 of the hand guard 210 is first moved to a position in which the spindle 350 (as illustrated in FIG. 16; alternatively spindle 330) is centered within the cylindrical barrel of the hand guard. As shown, the spindle extends upwardly from the upper surface of the mandolin, and preferably is perpendicular to a plane formed by the slicing ramp and runout plate.

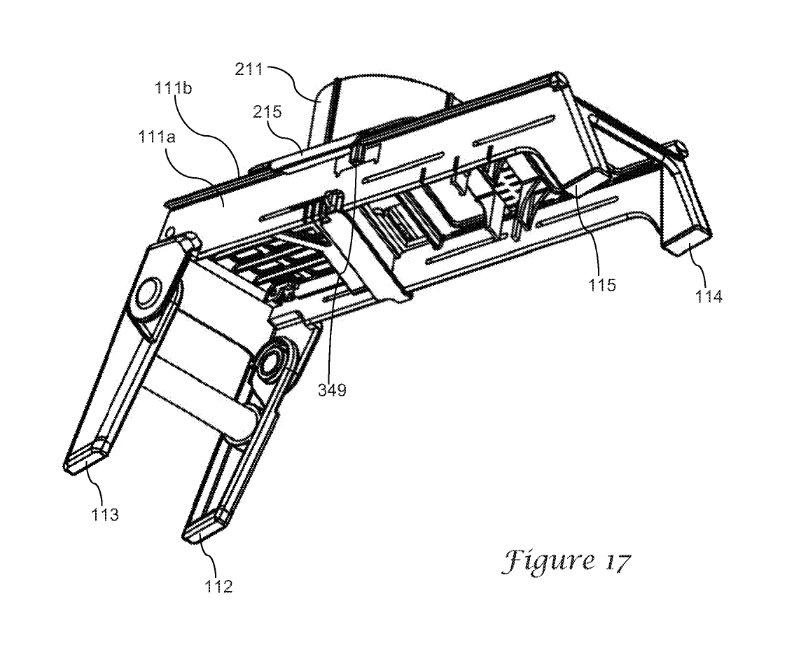

As an aid in positioning the barrel 211 of the hand guard 210 as described above, the spiral cut blade assemblies (either 320 or 340) include an outwardly extending stop (either 329 or 349), as described above. As best seen in FIG. 17, the lateral stop 349 extends laterally outward from the outer surface of the frame sidewall 111a. As the guide 215 rides along the upper rail 111b of the sidewall, it encounters the stop 349, which impedes further movement of the hand guard. In the illustrated example, the stop is oriented to allow the hand guard to travel from the slicing ramp toward the runout plate, stopping its path of travel upon reaching the stop. In other versions, the stop may be positioned differently, allowing the hand guard to travel in the opposite direction. Alternatively, the stop may be incorporated into the blade assembly in a different manner, such as on an interior surface rather than an exterior one.

The food item is mounted on the spindle 350, pressing the food item downward onto the spindle and the spiral blade assembly 340. Once mounted on the spindle, the food item (not shown) is rotated on the spindle in a clockwise direction, as indicated in by arrow C. Depending on the orientation of the blade, the direction for slicing may be reversed as may be appropriate. As the food item is rotated, it encounters the blade which cuts the food item and allows the cut portion to pass through the opening beneath the blade and onto a countertop or a dish placed beneath the mandolin.

When the food item is relatively large and extends sufficiently above the surface of the mandolin, the user can turn the food item by hand, rotating it as described above. When the food item is shorter, however, it is safer to use the pusher cap mounted to the hand guard. Accordingly, when the food item is sufficiently short, the pusher cap 220 is placed over the barrel of the hand guard. The lock button 290 is moved to the unlocked position, as indicated in FIG. 19. From this position, the lid 222, grip 240, piston and plunger plate (not visible in FIG. 19) can rotate axially with respect to the hand guard barrel. The spikes 260 will pierce the food item so that the food item rotates with the grip and lid. The user may then rotate the grip with respect to the barrel on the mandolin to rotate the food item at the same time. In accordance with the explanation above, the food item will be cut by the applicable spiral cutting blade assembly to produce a spiral cut food item.

The user may also create spiral cuts with ridges, using the ridged spiral cutting assembly 320. The user operates the mandolin in the same fashion as above, removing an installed blade assembly and replacing it with the spiral cutting assembly.

With the standard cutting assembly 300 installed, the user is able to operate the mandolin in conventional style. With the julienne blades retracted, standard slices are created. With one or both sets of julienne blades extending upward, the user may create strips or cubes from the food item.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A mandolin slicer, comprising:
a frame having a pair of opposing frame sidewalls and a downwardly extending lower support;
a slicing ramp positioned at a first end of the mandolin slicer and between the pair of frame sidewalls;
a runout plate positioned at a second end of the mandolin slicer and between the pair of frame sidewalls;
a first blade assembly positioned between the slicing ramp and the runout plate, and further positioned between the pair of frame sidewalls, the first blade assembly having:
a first spindle extending upwardly from the first blade assembly and located centrally between the pair of frame sidewalls;
a first spiral slicing blade extending between the first spindle and one of the pair of frame sidewalls; and
a first opening formed in the first blade assembly adjacent the first spiral slicing blade, the first opening extending along the length of the first spiral slicing blade.

2. The mandolin slicer of claim 1, further comprising a hand guard removably attachable to the frame, the hand guard forming a central barrel and a peripheral flange.

3. The mandolin slicer of claim 2, wherein the hand guard further comprises a guide and the pair of opposing frame members comprise a pair of rails, the guide engaging at least one of the pair of rails to retain the hand guard to the frame for sliding movement of the hand guard on the frame.

4. The mandolin slicer of claim 3, further comprising a stop positioned on the slicer, the stop being configured to position the barrel of the hand guard about the spindle when the hand guard engages the stop.

5. The mandolin slicer of claim 4, wherein the stop is attached to a sidewall of the first blade assembly and extends laterally away from the first blade assembly, and further wherein the guide engages the stop to position the barrel about the spindle.

6. The mandolin slicer of claim 5, wherein when the guide engages the stop, the spindle is located at the center of the barrel.

7. The mandolin slicer of claim 6, further comprising a pusher cap configured to attach to the hand guard, the pusher cap further having a plunger plate supported by a piston and a grip attached to the piston, the piston extending through the pusher cap, whereby the grip, the piston, and the plunger plate are axially moveable within the barrel of the hand guard when the pusher cap is attached to the hand guard.

8. The mandolin slicer of claim 7, wherein the plunger plate is attached for pivotal movement within the pusher cap.

9. The mandolin slicer of claim 8, wherein the pusher cap further comprises a lower body and a lid, the lid being attached to the lower body for rotational movement of the lid with respect to the lower body, and further wherein the piston extends through the lid and engaged with the lid for common rotational movement of the lid together with the piston.

10. The mandolin slicer of claim 9, further comprising a lock carried on the pusher cap, the lock being configurable between a locked position in which the lid is restricted from rotational movement with respect to the lower body, and an unlocked position in which the lid is rotationally moveable with respect to the lower body.

11. The mandolin slicer of claim 10, further comprising one or more spikes mounted to the lid and extending downward into the pusher cap, the plunger plate further having one or more holes, wherein the one or more spikes extends through the one or more holes.

12. The mandolin slicer of claim 1, wherein the first blade assembly is removably mounted to the frame.

13. The mandolin slicer of claim 12, wherein the pair of opposing frame members includes a first slot and a second slot, the first blade assembly further having a locking tab extending through the first slot and an end cap seated in the second slot.

14. The mandolin slicer of claim 13, wherein the end cap further comprises a stop extending laterally outward from the end cap.

15. The mandolin slicer of claim 14, further comprising a hand guard removably attachable to the frame, the hand guard forming a central barrel and a peripheral flange.

16. The mandolin slicer of claim 15, wherein the hand guard further comprises a guide and the pair of opposing frame members comprise a pair of rails, the guide engaging at least one of the pair of rails to retain the hand guard to the frame for sliding movement of the hand guard on the frame, the stop further being positioned on the end cap to engage the guide, wherein the spindle is located centrally within the barrel of the hand guard when the guide engages the stop.

17. The mandolin slicer of claim 12, further comprising a second blade assembly, the second blade assembly having:
a second spindle extending upwardly from the second blade assembly and located centrally between the pair of frame sidewalls when the second blade assembly is mounted to the slicer and the first blade assembly is removed from the slicer;
a second spiral slicing blade extending between the first spindle and one of the pair of frame sidewalls when the second blade assembly is mounted to the slicer and the first blade assembly is removed from the slicer; and
a second opening formed in the second blade assembly adjacent the first spiral slicing blade, the second opening along the length of the first spiral slicing blade.

18. A mandolin slicer, comprising:
a frame having a first frame sidewall and an opposing second frame sidewall, the frame being supported by a downwardly extending lower support;
a slicing ramp positioned at a first end of the mandolin slicer and between the first frame sidewall and the second frame sidewall, each of the first frame sidewall and the second frame sidewall extending above the slicing ramp in a direction away from the lower support;
a runout plate positioned at a second end of the mandolin slicer and between the first frame sidewall and the second frame sidewall;
a first spindle mounted on the slicer and extending upwardly in a direction away from the lower support, the first spindle further being positioned between the first frame sidewall and the second frame sidewall;
a first spiral slicing blade extending between the first spindle and the first frame sidewall, the first spiral slicing blade further not extending between the first spindle and the second frame sidewall; and
a first opening formed adjacent the first spiral slicing blade, the first opening extending along the length of the first spiral slicing blade.

19. The mandolin slicer of claim 18, further comprising a hand guard removably attachable to the frame, the hand guard forming a barrel with an open top and a having a peripheral flange, the frame further comprising a stop configured engage the hand guard and to position the barrel of the hand guard about the spindle when the hand guard engages the stop, whereby the spindle is accessible through the open top of the barrel when the hand guard engages the stop.

20. The mandolin slicer of claim 19, further comprising a pusher cap removably attachable to the hand guard, the pusher cap further having a piston extending through the pusher cap and a grip attached to the piston, whereby the grip and the plunger are axially moveable within the barrel of the hand guard when the pusher cap is attached to the hand guard.

21. The mandolin slicer of claim 20, wherein the pusher cap further comprises a lid, the lid being attachable to the hand guard for rotational movement of the lid with respect to the hand guard, and further wherein the piston extends through the lid and is engaged with the lid for common rotational movement of the lid together with the piston.
